(19) United States
(12) Patent Application Publication
(10) Pub. No.: US 2025/0196001 A1
(43) Pub. Date: Jun. 19, 2025

(54) SOCIALLY RICH PLAYER ENGAGEMENT TECHNIQUES FOR COMPUTER GAMEPLAY

(71) Applicant: Sony Interactive Entertainment Inc., Tokyo (JP)

(72) Inventors: Michael Taylor, San Mateo, CA (US); Charles Denison, San Mateo, CA (US); Thomas Mitchel, San Mateo, CA (US)

(21) Appl. No.: 18/538,873

(22) Filed: Dec. 13, 2023

(51) Int. Cl. A63F 13/52; A63F 13/426; A63F 13/86

(52) U.S. Cl. CPC A63F 13/52; A63F 13/426; A63F 13/86

(57) ABSTRACT

Techniques and devices are described for building 3D drawings within a 3D scene sourced from a game engine (or other video source) without the benefit of 3D data and other metadata from the game engine itself. Accordingly, in one aspect an apparatus may include at least one processor assembly that is configured to access a parameterization of a virtual 3D space and to receive user input directed to an object represented in the virtual 3D space. The at least pone processor assembly may also be configured to, based on the user input, change the parameterization of the virtual 3D space to represent the user input within the virtual 3D space from different viewing angles.

### FIELD

The disclosure below relates to technically inventive, non-routine solutions that are necessarily rooted in computer technology and that produce concrete technical improvements, and more specifically to socially rich player engagement techniques for computer gameplay.

### BACKGROUND

As understood herein, designing computer games to be more realistic and interactive for players and viewers alike can add to the immersive nature and enjoyment of the games themselves. However, there are instances where adding user input to a computer game is difficult without access to the game engine itself. There are currently no adequate solutions to the foregoing computer-related, technological problem.

### SUMMARY

As further understood herein, 3D rendering technology can be improved by building graphical objects corresponding to drawing or chalk input within a 3D scene without the benefit of 3D data and other metadata from the game engine itself.

Accordingly, in one aspect an apparatus includes at least one processor assembly that is configured to access a parameterization of a virtual three-dimensional (3D) space and to receive user input directed to an object represented in the virtual 3D space. The at least one processor assembly is also configured to, based on the user input, change the parameterization of the virtual 3D space to represent the user input within the virtual 3D space from different viewing angles.

If desired, the at least one processor assembly may also be configured to output a visualization of the virtual 3D space on a display according to the change(s) in the parametrization of the virtual 3D space.

The parametrization itself may be established at least in part by a neural representation. For example, the neural representation may be composed of one or more Gaussian or Wavelet volumetric representations. Additionally or alternatively, the neural representation may include a neural network, such as a neural radiance field (NeRF). As another example, the parametrization may be established at least in part by a 3D mesh.

Also in some example implementations, the user input may include drawing input directed to the object. Still further, the user input may include voice input associated with the object. E.g., the voice input may indicate a way in which the drawing input is to be incorporated into the virtual 3D space.

What's more, in some cases the at least one processor assembly may be configured to generate the parameterization from computer game video. The parameterization may be generated without access to metadata from a game engine used to generate the computer game video. Additionally, the parameterization may be generated using one or more implicit representations such as a signed distance function determined from the game video, if desired.

Further still, in some examples the at least one processor assembly may be configured to, responsive to a threshold amount of time expiring from the change in the parametrization, use the parametrization without the change(s) to subsequently render video of the virtual 3D space.

If desired, in some specific instances the parameterization may be changed to represent the user input within the virtual 3D space as a drawing anchored to the object, where the drawing may be assigned a translated or rotated geometry within the virtual 3D space and in relation to the object. The drawing itself might be represented as digital chalk. So in one example, the object may be a computer game character and the drawing may follow the computer game character as the computer game character moves within the virtual 3D space. In another example, the object may be a game world path and the drawing may be virtually laid along the game world path within the virtual 3D space.

In another aspect, a method includes accessing a parameterization of a three-dimensional (3D) space shown in video and receiving user input directed to an object shown in the video. The method also includes, based on the user input, changing the parameterization of the 3D space to represent the user input in the 3D space. The method then includes representing, on a display and based on the changing of the parametrization of the 3D space, the user input in the 3D space from different viewing angles.

In yet another aspect, an apparatus includes at least one computer medium that is not a transitory signal. The at least one computer medium includes instructions executable by at least one processor assembly to access a parameterization of a three-dimensional (3D) space and to receive user input directed to an object shown in a base video associated with the 3D space. The instructions are also executable to, based on the user input, change the parameterization of the 3D space to represent in a modified video the user input in relation to the object. The modified video is derived at least in part from the base video.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2 and 3 illustrate different viewing angles of digital chalk drawn along a virtual footpath within a computer game world consistent with present principles;

FIG. 4 illustrates digital chalk as anchored to a game character as the character moves about in a computer game world consistent with present principles; and

FIG. 5 illustrates example logic in example flow chart format consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

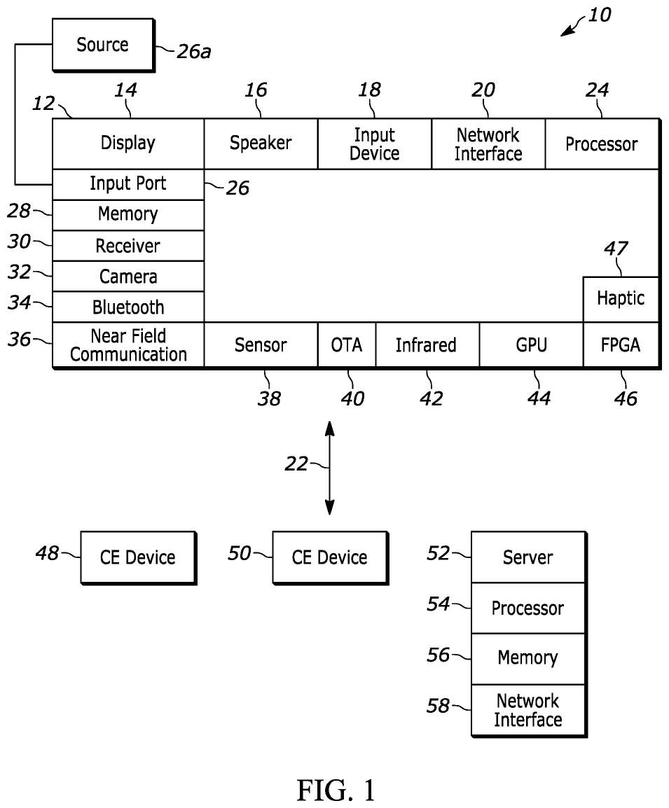

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), recurrent neural network (RNN) which may be appropriate to learn information from a series of images, and a type of RNN known as a long short-term memory (LSTM) network. Support vector machines (SVM) and Bayesian networks also may be considered to be examples of machine learning models.

As understood herein, performing machine learning involves accessing and then training a model on training data to enable the model to then process further data to make predictions/inferences during deployment. For example, back propagation may be used during training to change the weights of the model. A neural network may include an input layer, an output layer, and multiple hidden layers in between that are configured and weighted to make inferences about an appropriate output.

Present principles deal in part with shared experiences in distributed computer gaming, made possible through the technical graphics rendering improvements set forth herein.

In one aspect, a viewer of a computer game (e.g., not a person providing inputs to play the game) may therefore still provide viewer input via a cursor or touch-based input, drawing digital smart chalk or other markings on the screen for presentation to other distributed players and viewers. The system may do so even without access to metadata and other data from the game engine itself, instead analyzing the resulting game video output by the engine for rendering on the display screens of the different viewers and players. The system may thus analyze where, as a virtual geolocation within the three-dimensional (3D) game world, a particular game camera/field of view (FOV) was within the 3D game world when the relevant image or video being analyzed was taken (the image/video output by the game engine).

With the positional knowledge of the camera/FOV inferred, ray casting and other technique/algorithms (e.g., COLMAP and/or signed distance functions) may then be used to determine the geometry and spatial relationship between different graphical objects within the game world, as seen through the different views/perspectives from the images/video output by the game engine.

With 3D positional data, surface/feature data, and color data then known for the different objects within the 3D game world, digital chalk or other markings may be provided by a user and converted from their 2D base coordinates (e.g., X-Y display coordinates) into a translated 3D graphical rendering within the game world. The 3D rendering may have a geometric relationship with respect to one or more game world objects so that the 3D chalk rendering maintains that relationship as FOVs of the game world and relevant game characters themselves change position.

Additionally, note that the system lacking access to the game engine or other game data need not necessarily be a matter of incompatibility or inconvenience. Instead, present principles recognize that technical standardization is desirable across multiple different games that might be played on a given gaming platform, and hence present principles may be instituted at the platform/console level. Additionally, as the game engine is focused on rendering the game as fast as possible for seamless gameplay, the game engine is often too overburdened to dynamically add in viewer inputs that then stay attached in a 3D spatial relationship with other game objects.

Note that present techniques for graphics rendering may encompass video for legacy games as well, where those legacy games might not have a modern game engine at all or may have one that is so old and different as to not be compatible. Present techniques may also encompass renderings for video not related to computer games but instead related to user-generated real-world red green blue (RGB) video and/or computer graphics-based video from Internet tube sites, social media, etc. Those types of video therefore include not just real-world RGB video but also animated video, augmented reality (AR) video, virtual reality (VR) video, and other types of mixed reality (MR) video.

With the foregoing in mind, in one aspect a system (one or more devices) operating consistent with present principles may receive computer game video data as provided by a graphics shader that is being used for video rendering. The game video data from the shader may be analyzed so that 3D virtual spatial relationships amongst graphical objects in the video may be extracted out. This spatial data need not necessarily be extracted in real time during the computer game as that might unduly slow down the rendering pipeline itself. But once the geometric data for each graphical object and spatial data of objects with respect to each other within the game world are known (e.g., executed as a background process while gameplay continues), user chalk may then be superimposed into the game scene. For example, the system may seamlessly change color data with relatively low processor burden and insert the modified video back into the shader pipeline for rasterization and rendering. Thus, the game rendering pipeline itself may be left intact and unaffected, with present principles picking up toward the end of the rendering process at the shader pipeline by inserting persistent metadata that can adapt outside of the game itself. Thus, the modified video with the drawings may be played out instead.

However, in addition to or in lieu of using a shader, particular techniques for video rendering with added chalk tied to game world geometry may include changing the weights of a neural network, such as a neural radiance field (NeRF), being used to help render the game world. 3D Gaussians or Wavelets may also be used, where volumetric representations may be composed together in virtual space (e.g., through a depth buffer) to render a 3D image of the game world as projected down onto the camera/viewing plane.

These types of parametrizations of the game world, where virtual objects are in known coordinates in 3D game space, may be used so that when it comes time to simultaneously render different game video of the same game instance for different viewers viewing the same world from different viewing angles, the objects may be ordered and projected onto the respective 2D FOV of each individual viewer to show a 3D representation of the viewer's chalk. An editable neural representation of the game world (one example of a parametrization of the game world) may be derived from a game livestream using techniques, such as inverse rendering, to then concurrently produce different modified game videos from different viewing angles for different simultaneous views of the game world (e.g., at remote real-world physical locations where different viewers/players are located). The neural representation may thus represent the 3D data of the game world itself in terms of position, surface features, and color of different graphical objects within the game world. The neural representation thus provides the ability to edit the virtual world geometry itself by changing the weights of the neural representation.

Thus, a system operating consistent with may understand the game world's 3D space without access to the game engine so that when a viewer draws onscreen, the drawing does not stay static and unmoving on top of the screen in 2D where it would eventually lose the context to the gameplay itself. Instead, the 2D drawing is translated into a 3D object that gets inserted into the 3D game world and played out to the viewer even without help from the game engine.

Accordingly, in one aspect a form of digital smart chalk may be provided where something might be drawn into 3D virtual space within the game world through 2D input. As the video plays out, the lines that were drawn stay referential to specific 3D points in the virtual world and do not simply stay unchanging onscreen or in within a given FOV in which they were drawn. Rather, the drawings are anchored with respect to the geometry of the world according to how they were drawn, with this being done using the neural representation or other parametrization of the 3D game space, where different viewpoints of the game camera were used to recreate the game world after output from the game engine but with added chalk representations posed within the game world. The 3D chalk may thus exist with everything else in the 3D game world as played out to the viewer. Thus, as the camera moves around game space, different chalk drawings anchored to different graphical objects may be inserted, it being further noted that those graphical objects need not be immovable but might move around the game world themselves such that the 3D representation of the chalk moves along with them.

FOV/camera position and direction, determined external to the game engine but from the game video output by the game engine itself, may therefore be used along with the parametrization of the game's virtual world to output a modified game video from the same position/perspective as the base video, but with chalk superimposed geometrically within the 3D game world with respect to other game world object(s).

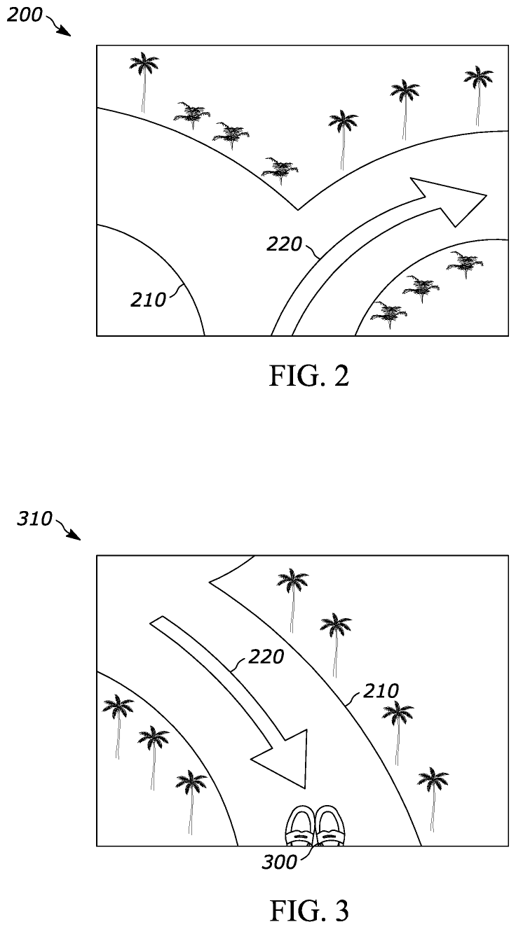

FIGS. 2 and 3 show one example of present principles. Suppose according to the example shown that a non-player viewer of a computer game is watching a first-person view 200 of a game world according to the character view of a particular human player. As shown in FIG. 2, the view 200 shows a virtual footpath 210 with a fork in the road in 3D. The non-player viewer might then use a stylus or touch input to draw on the viewer's touch-enabled display screen, providing digital chalk input to draw a line/arrow 220 along the path to the right side of the fork as shown. The viewer might to so to show the gamer the correct path to take with the gamer's character, or to let others know the correct path to take with their own respective game characters. As such, even though the drawing input was provided in 2D on the viewer's own display screen, the drawing input may be translated into 3D space and laid down geometrically along the plane of the footpath 210 so that it looks as though it is painted or laid down in the path in 3D virtual space.

Thus, as shown in FIG. 3, should another gamer approach the same right-side portion of the fork from the opposite virtual direction with a different game character (shoes 300 of that different character being shown according to the first-person FOV for that character), the line 220 may still be shown but from a different geometric 3D perspective within the game world according to the different first-person view 310 of the other character. FIG. 3 therefore shows that the arrow 220 is now pointing toward the virtual position of the second person's game character but is still laid down on the same geometric virtual plane of the path 210. With this in mind, it may be more generally appreciated that as different people simultaneously navigate the same 3D game world instance output by the game engine from their own respective game world perspectives (e.g., using different game characters or viewer cameras), the arrow 220 may be geometrically laid down on the path 210 and geometrically presented differently in 3D according to each different viewing perspective within the 3D space.

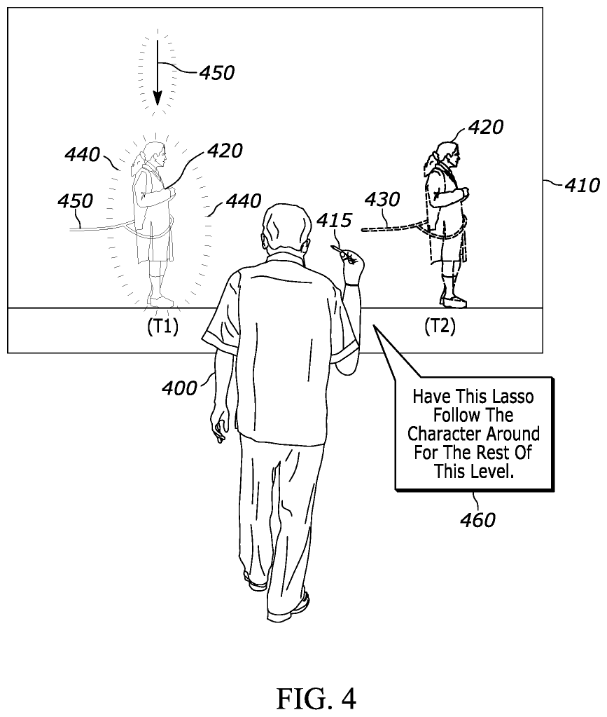

FIG. 4 shows another example. Here a real-world non-player viewer is viewing a game livestream as presented on the display of his/her tablet computer 410. At time T1, the viewer 400 draws a digital chalk lasso 430 in 2D around the waist of a game character 420 controlled by a gaming user. The chalk might be drawn on top of the tablet's display screen using a finger or stylus 415, for example. Note as also shown in FIG. 4 that the lasso 430 has a rope tail of a certain length as defined by the chalk drawing made by the viewer 400 in 2D.

FIG. 4 further illustrates that in some examples, one or more indications of graphical object selection may be provided so that the user can discern the game object that the system has determined as the one to which ensuing chalk is to be anchored. In the present example, the graphical indications include a halo effect of light rays 440 around the character 420 as well as a glowing, bobbing arrow 450. Also note that the object selection itself may occur through receipt of touch input touching the object as presented on the user's display, voice input identifying the object for selection, etc. that occurred within a threshold time before the drawing input itself was received.

Then, at a later time T2 still during live gameplay of the same game instance, the character 420 has moved to a different position within the game world as illustrated by the perforated version of the character 420 also shown in FIG. 4. Note here that the chalk drawing of the lasso 430 has not remained at the same onscreen location on the display of the tablet computer 410 but has instead moved within the game world in 3D with the character 420 themselves since it is anchored to that character's waist. The lasso 430, including the rope tail of the certain user-defined length, therefore remains virtually attached to the character 420 as the character 420 moves around the game world. What's more, the lasso 430 may be translated from 2D onscreen drawing into virtual 3D spatial geometry so that its presentation is not confined to the static way in which it was drawn onscreen but instead is inserted into 3D space so that it may be presented differently geometrically in 3D within the game world according to different 3D perspectives of different viewers. The drawing may therefore be presented in 3D to still be looped around the waist of the character 420 according to this example but may show from different viewing angles.

FIG. 4 also shows that in some examples, in addition to providing 2D drawing input, voice input may also be provided to a speech recognition engine operating at the system (e.g., a digital assistant or speech-to-text software operating on a cloud server). The voice input may help the system determine how the 2D drawing input is to be geometrically represented within the 3D environment and tied to a given existing game object. In the present example, speech bubble 460 indicates that the voice input is “Have this lasso follow the character around for the rest of this level.” Natural language understanding or other voice processing algorithms may then be executed on the recognized speech to determine both that the voice input itself is associated with the lasso 430 that was drawn and to determine a time limit for which the lasso 430 is to be anchored on the waist of the character 420 before disappearing from the game world (the rest of the current game level in this example).

It may therefore be appreciated that using a neural representation or other type of video world parametrization consistent with present principles, user-provided 2D drawings on a display screen may be naturally and geometrically blended into the 3D scene itself and subsequently represented in 3D as tied to a given game object (rather than staying static on screen where they were drawn). The drawings may also be propagated upstream to other viewers, possibly with their own differing viewing angles of the same 3D virtual world, since each perspective may be rendered using the same neural parametrization of the 3D space (e.g., as maintained at a cloud server). Chalked 3D objects may thus be shared across an entire group of viewers, with the way in which the chalk is rendered changing over time and showing different geometric surfaces of the chalk depending on the particular viewing angle.

Note that in addition to neural networks such as NeRFs and also in addition to 3D Gaussian or Wavelets, another type of parametrization that may be used consistent with present principles is a 3D mesh that might itself be generated from a NeRF. The graphic rendering system may then use mesh rendering tools to analyze the contours of the 3D mesh to figure out how to add user chalk to the mesh (with the chalk having its own mesh contours) so that the modified mesh with chalk added can be pushed back into the neural representation for subsequent rendering of the chalk from different FOVs using the altered neural representation. Thus, here again by having a surface representation of 3D space, the system can move the FOV around the surface and show the chalk within the 3D world even absent access to the game engine/image assembly engine.

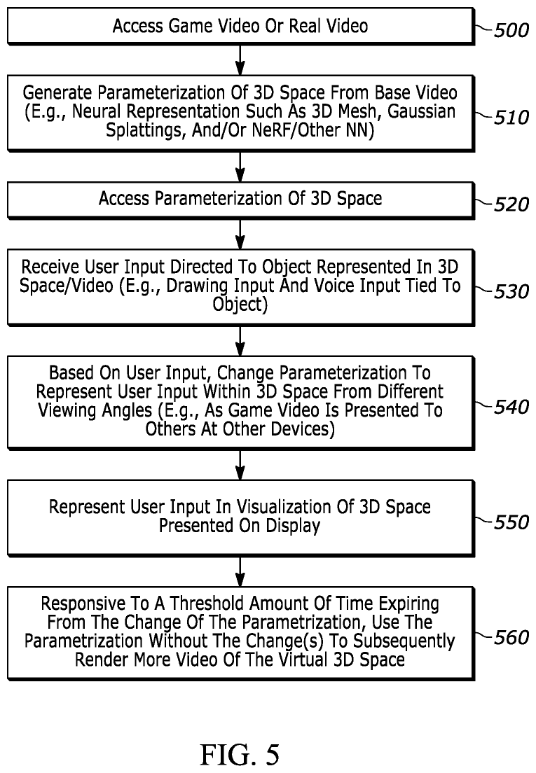

Referring now to FIG. 5, it shows example logic that may be executed by a device such as the system 10, a smartphone, an augmented reality (AR) or VR head-mounted display, a server, and/or any combination thereof consistent with present principles. Note that while the logic of FIG. 5 is shown in flow chart format, other suitable logic may also be used.

Beginning at block 500, the device may access computer game video, animated video, or real world RGB video which might be streamed over the Internet or accessed from local storage. The logic may then proceed to block 510.

At block 510 the device may generate a parameterization from the accessed base video. In terms of computer game video, note again that the parameterization may be generated without access to metadata from a game engine used to generate the computer game video.

As a specific example, the parameterization may be generated using one or more implicit representations such as signed distance functions determined from the game video or other video. The parametrization itself may be established at least in part by a neural representation, such as one or more 3D Gaussians or Wavelets, a neural network like a NeRF, and/or a 3D mesh.

From block 510 the logic may then proceed to block 520. At block 520, at a later time than when the parameterization was generated (such as during live gameplay after the parameterization was generated for a given 3D game world), the parameterization of the 3D space from the base video may be accessed. The logic may then proceed to block 530.

At block 530 the device may receive 2D user input directed to an object represented in the 3D space, such as drawing input, or both drawing input and voice input per the example above (e.g., voice input that indicates a way in which the drawing input is to be incorporated into the 3D space). The user input may be tied to an object shown in the base video, whether that object is real or virtual. Then at block 540, based on the 2D user input, the device may change the parameterization of the 3D space to represent the 2D user input within the virtual 3D space in 3D from different viewing angles.

For example, in the case of drawing input that is to be attached to a game object that itself moves within the 3D world of the video (e.g., a lasso around a game character), the path of the 2D drawing input may be converted into a 3D cylinder extending in the shape of the path. The 3D cylinder may therefore exist across 3D virtual coordinates that are mapped into 3D space from the 2D coordinates of the drawing input itself (e.g., via a projection matrix). The translated or rotated geometry of the cylinder (e.g., length and transverse diameter of the resulting 3D cylinder) that traces the shape of the 2D drawing input across the 3D world may be proportional to the 2D drawing input itself (length and width of the drawing input). Thus, the drawing stroke length and width, and resulting cylinder length and diameter, may be the same relative to the presented size of the associated object itself when the drawing input was received, even as the object and cylinder are viewed from different angles in the 3D world.

In the case of a drawing that is to remain drawn on a 3D surface in the 3D world of the video (e.g., an arrow drawn along a path, or chalk writing on a 3D wall within the 3D world), rather than a cylinder, the 2D input may used to change the surface color of the relevant 3D object itself at certain points to represent the drawing input as virtual drawings or other markings on the associated 3D object itself.

Therefore, the drawing input may be presented to others as part of a live game video of a computer game that is currently being played or as part of an RGB video from an online video sharing site. Thus, at block 550 the device may output a visualization of the 3D space on a display according to the change(s) in the parametrization of the 3D space to thus represent the drawing input in the 3D space as the FOV changes within the 3D space over time, such as based on character movement within a game world or based on the FOV of a RGB video changing as the video progresses.

After block 550 the logic may then proceed to block 560. At block 560 the device may, responsive to a threshold amount of time expiring from the change in the parametrization, use the parametrization without the change(s) to subsequently render additional video of the virtual 3D space. For example, the device may undo the changes to the parametrization, or may revert to a saved prior version or base parametrization from prior to the changes. This may be done to erase the digital chalk from the 3D space itself. Additionally, note that the threshold time may be a particular amount of time such as thirty seconds, or may be an amount of time measured in terms of an event such as completion of a game level according to the example above.

It may now be appreciated that in generating a base parametrization of a 3D world shown in video and then changing the parametrization to include drawing input, an alternate 3D world may be played out with everybody viewing the alternate 3D world that tracks the base world from different viewing angles and adds in user drawings.

Additionally, it is to be understood that drawing input may be provided using a video game controller-controlled cursor, touch pad-controlled cursor (e.g., touch pad on video game controller or laptop computer), a touch-enabled display, free-space finger movement as tracked using a camera and computer vision, etc.

It is to also be understood that present principles may be extended to even create an alternate game engine that predominantly uses volumetric representations as a procedural method to render only what gets presented to the user rather than every 3D aspect of a given virtual space.

The volumetric representations may be comprised of/include bandlimited parameterized signals such as Gaussians or Wavelets. The set of Gaussians or Wavelets may be composed together to represent objects and the geometry of a scene. Gaussians and Wavelets are examples of spatially localized basis functions.

In terms of basis functions consistent with present principles, note that spherical harmonics may be used to represent view-dependent effects and lighting within the virtual world so that surfaces change color when viewed from different angles. Volumetric representations therefore need not even use a neural network but can still be used for 3D editing in real time. Using a point cloud (e.g., sparse point cloud from the spherical harmonics), respective volumetric representations may therefore be centered on each point in the cloud, and then through iterative optimization the volumetric representations may be adjusted to match the original images that were captured. The density of the volumetric representations may also be adjusted so that more signal exists in viewing directions/FOV of the user and less might exist in other portions of the 3D world. View-dependent lighting may then be modeled using the spherical harmonics, potentially optimizing the base color at first and then progressively optimizing higher frequency bands over time.

The 3D scene may therefore be reconstructed from learned volumetric representations, where relative 3D positioning of objects within the video may be determined using back propagation to learn a sparse 3D world space where the volumetric representations may then be centered on each point in the world, with some volumetric representations corresponding to the added drawings from the user and others corresponding to the initial 3D world. An optimization process may thus be used for rendering volumetric representations according to the original view from the video, using gradients to optimize the parameters of the volumetric representation (e.g., position, size, orientation) to match the base images over time while also adding in the drawing input. Additionally, for instances where there is still not sufficient detail during optimization, adaptive density control may also be used. To render the modified 3D world, optimized volumetric representation may thus be alpha-blended, rasterized, and projected onto the image plane for presentation. As this can be done consistent with present principles at relatively high frames per second, this type of unstructured volumetric representation may provide both speed and image quality, avoiding over-burdening the graphics processing unit (GPU) being used to produce the video itself.

While particular techniques are herein shown and described in detail, it is to be understood that the subject matter which is encompassed by the present application is limited only by the claims.

What is claimed is:

1. An apparatus, comprising:
at least one processor assembly configured to:
access a parameterization of a virtual three-dimensional (3D) space;
receive user input directed to an object represented in the virtual 3D space; and
based on the user input, change the parameterization of the virtual 3D space to represent the user input within the virtual 3D space from different viewing angles.

2. The apparatus of claim 1, wherein the at least one processor assembly is configured to:
output a visualization of the virtual 3D space on a display according to the change(s) in the parametrization of the virtual 3D space.

3. The apparatus of claim 1, wherein the parametrization is established at least in part by a neural representation.

4. The apparatus of claim 3, wherein the neural representation comprises one or more volumetric representations, the volumetric representations comprising one or more Gaussian representations and/or one or more Wavelet volumetric representations.

5. The apparatus of claim 3, wherein the neural representation comprises a neural network.

6. The apparatus of claim 5, wherein the neural network is a neural radiance field.

7. The apparatus of claim 1, wherein the user input comprises drawing input directed to the object.

8. The apparatus of claim 7, wherein the user input comprises voice input associated with the object.

9. The apparatus of claim 8, wherein the voice input indicates a way in which the drawing input is to be incorporated into the virtual 3D space.

10. The apparatus of claim 1, wherein the at least one processor assembly is configured to:
generate the parameterization from computer game video.

11. The apparatus of claim 10, wherein the parameterization is generated without access to metadata from a game engine used to generate the computer game video.

12. The apparatus of claim 10, wherein the parameterization is generated using one or more signed distance functions determined from the game video.

13. The apparatus of claim 1, wherein the parametrization is established at least in part by a 3D mesh.

14. The apparatus of claim 1, wherein the at least one processor assembly is configured to:
responsive to a threshold amount of time expiring from the change of the parametrization, use the parametrization without the change(s) to subsequently render video of the virtual 3D space.

15. The apparatus of claim 1, wherein the parameterization is changed to represent the user input within the virtual 3D space as a drawing anchored to the object, the drawing assigned a translated or rotated geometry within the virtual 3D space and in relation to the object.

16. The apparatus of claim 15, wherein the drawing is represented as digital chalk.

17. The apparatus of claim 15, wherein the object is a computer game character, and wherein the drawing follows the computer game character as the computer game character moves within the virtual 3D space.

18. The apparatus of claim 15, wherein the object is a game world path, and wherein the drawing is virtually laid along the game world path within the virtual 3D space.

19. A method, comprising:
accessing a parameterization of a three-dimensional (3D) space shown in video;
receiving user input directed to an object shown in the video;
based on the user input, changing the parameterization of the 3D space to represent the user input in the 3D space; and
representing, on a display and based on the changing of the parametrization of the 3D space, the user input in the 3D space from different viewing angles.

20. An apparatus comprising:
at least one computer medium that is not a transitory signal and that comprises instructions executable by at least one processor assembly to:
access a parameterization of a three-dimensional (3D) space;
receive user input directed to an object shown in a base video associated with the 3D space;
based on the user input, change the parameterization of the 3D space to represent, in a modified video, the user input in relation to the object, the modified video derived at least in part from the base video.
